(19) United States
(12) Patent Application Publication
(10) Pub. No.: US 2006/0130138 A1
(43) Pub. Date: Jun. 15, 2006

(54) Automated transaction control method, automated transaction device, and storage medium stored program for same

(75) Inventors: Kenichi Chigira, Maebashi (JP); Shuuichi Izawa, Maebashi (JP); Yuuichi Narita, Maebashi (JP); Takahiro Kudou, Maebashi (JP); Kiyotaka Awatsu, Inagi (JP); Masako Fujiwara, Inagi (JP); Sagiri Okamura, Inagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki (JP); FUJITSU FRONTECH LIMITED, Inagi-shi (JP)

(21) Appl. No.: 11/116,447

(22) Filed: Apr. 28, 2005

(30) Foreign Application Priority Data
Dec. 10, 2004 (JP) 2004-357488

(51) Int. Cl. G06F 12/14

(52) U.S. Cl. 726/17

(57) ABSTRACT

An automated transaction device verifies individual data on storage media against input individual data and performs automated transactions. An automated transaction device has biometrics authentication functions realized in a biometrics unit. A control unit of the device detects abnormal in the biometrics unit at the start of a transaction, and upon detecting an error, effects a transition to a conventional transaction based on password authentication using an IC card. Even when an abnormal occurs in the biometrics unit, a transaction based on conventional authentication is possible.

### CROSS-REFERENCE TO RELATED APPLICATIONS

This application is based upon and claims the benefit of priority from the prior Japanese Patent Application No. 2004-357488, filed on Dec. 10, 2004, the entire contents of which are incorporated herein by reference.

### BACKGROUND OF THE INVENTION

1. Field of the Invention

This invention relates to an automated transaction control method, automated transaction device, and storage medium stored program for same to verify input data obtained from a user against individual data on storage media held by the user in order to perform automated transaction, and in particular relates to an automated transaction control method, automated transaction device, and storage medium stored program for same which utilize a biometrics authentication unit to read biometrics information for the user, and verify the information against registered biometrics information.

2. Description of the Related Art

Automated transaction machines which are operated by users are in wide use. Such automated transaction machines include automated cash dispensers, automated deposit/withdrawal machines, and automated balance transfer machines for financial transactions, as well as automated ticket dispensers and automated certification document dispensers.

Such automated transaction machines are operated by users to perform deposit/withdrawal, cash transfer, document issuing, and other transactions. Hence from the standpoint of prevention of illicit operations, it is essential that such automated transaction machines perform individual authentication of users. In the individual authentication methods of the automated transaction device used in the prior art, a card on which is recorded individual information is issued, and when performing the automated transaction, a card password number or other individual data is read and is compared with the password number input by the user.

Through advances in computer technology in recent years, such password-based individual authentication methods, which are specific to users, entail the use of simple strings of numbers which can be easily analyzed, and so from the standpoint of preventing illicit operations have become unsatisfactory. Hence various biometric-based authentication technologies utilizing biometrics characteristics have been proposed for use in an automated transaction.

The human body has numerous portions enabling identification of the individual, such as fingerprints, the retinas of the eyes, facial characteristics, and blood vessels. Advances in biometrics technology in recent years have led to the proposal of various devices for identification of such biometrics characteristics which are one portion of the human body, to perform an automated transaction (see Japanese Patent Laid-open No. 2003-256912).

For example, blood vessel patterns in the palms and fingers or palm-prints constitute a comparatively large amount of individual characteristic data, and so are appropriate to ensure reliability of individual authentication. In particular, blood vessel (vein) patterns remain unchanged throughout life from infancy, and are regarded as being completely unique, and so are well-suited to individual authentication. FIG. 13 through FIG. 16 explain conventional palm authentication techniques. As shown in FIG. 13, at the time of registration or authentication, the user places the palm of the hand 110 into proximity with an image capture device 100. The image capture device 100 emits near-infrared rays, which are incident on the palm of the hand 110. The image capture device 100 uses a sensor to capture near-infrared rays rebounding from the palm of the hand 110.

As shown in FIG. 14, hemoglobin in the red corpuscles flowing in the veins 112 has lost oxygen. This hemoglobin (reduced hemoglobin) absorbs near-infrared rays at wavelengths near 760 nanometers. Consequently when near-infrared rays are made incident on the palm of a hand, reflection is reduced only in the areas in which there are veins, and the intensity of the reflected near-infrared rays can be used to identify the positions of veins.

As shown in FIG. 13, the user first uses the image capture device 100 of FIG. 13 to register vein image data of the palm of his own hand in a server or on a card. Then, in order to perform an automated transaction, the user employs the image capture device 100 of FIG. 13 to read the vein image data of his own hand.

The automated transaction is performed by comparing the patterns of veins in the registered vein image retrieved using the user's ID recorded on a card and in the vein verification image thus read. For example, on comparing the vein patterns in the registered image and a verification image as in FIG. 15, the individual is authenticated as the individual in question. On the other hand, upon comparison of the vein patterns in a registered image and in a verification image as in FIG. 16, the individual is not authenticated (see for example Japanese Patent Laid-open No. 2004-062826).

In such an automated transaction device, when installed a biometrics unit which captures image of human face, following method is proposed (see for example Japanese Patent Laid-open No. 2003-256912). That is, a combination of a biometrics authentication and a password authentication is adopted. And when an individual authentication is not successful using the biometrics authentication and when an individual authentication is not successful using the password authentication even an authentication is repeated at plural number, a transaction process is interrupted.

Since the biometrics unit is attached to the automated transaction device and captures an image of a living body and extracts a characteristics data of the living body at a transaction start, correct operation is required. That is, since the automated transaction device is operated by an user himself in a vacant environment, when the biometrics unit does not operate, the user who does not know the knowledge of the unit is at a loss what is caused, so making a cause of a trouble.

Furthermore, in a biometrics authentication of which a high accuracy authentication is a sales point, if the above trouble is occurred, the user feels that it is not convenient to use biometrics authentication. So, it is fear to impede a wide spread of the automated transaction machine having the biometrics authentication.

### SUMMARY OF THE INVENTION

Hence one object of the invention is to provide an automated transaction control method, automated transaction device, and storage medium stored program for same to improve the service for the user provided by the automated transaction device installed the biometrics authentication functions.

Another object of this invention is to provide an automated transaction control method, automated transaction device, and storage medium stored program for same to improve the service for the user even though the biometrics authentication makes abnormal.

Still another object of this invention is to provide an automated transaction control method, automated transaction device, and storage medium program for same to provide a transaction service to the automated transaction device installed biometrics authentication functions by another authentication except the biometrics authentication.

In order to attain these objects, an automated transaction device of this invention reads individual data from storage media of a user, verifies the read data against input individual data, and performs automated transactions. The automated transaction device has a media reading unit which reads the storage media of said user; a biometrics unit which verifies registered biometrics characteristic data according to the individual data of the storage media against said biometrics characteristic data detected from a body of the user, and performs individual authentication; and a control unit which performs automated transactions according to the authentication result of the biometrics unit. And the control unit performs non-biometrics authentication in which individual data of the storage media is verified against input individual data, and executes an automated transaction, when detecting abnormality of the biometrics unit at a start of an automated transaction.

An automated transaction control method of this invention has the steps of: detecting whether a biometrics unit is abnormal or not; verifying biometrics characteristic data registered for individual data on storage media against the biometrics characteristic data detected from body using a biometrics unit, and performing biometrics authentication when the biometrics unit is normal; executing an automated transaction based on the biometric authentication when the result of said biometric authentication is satisfactory; and verifying individual data of the storage media against input individual data, performing non-biometrics authentication for individual authentication, and executing an automated transaction when the biometrics unit is abnormal.

A computer readable storage medium stored program which causes a computer to execute the steps of: detecting whether a biometrics unit is abnormal or not; verifying biometrics characteristic data registered for individual data on storage media against the biometrics characteristic data detected from body of an user using a biometrics unit, and performing biometrics authentication when the biometrics unit is normal; executing an automated transaction based on the biometric authentication when the result of the biometric authentication is satisfactory; and verifying individual data on the storage media against input individual data, performing non-biometric authentication for individual authentication, and executing an automated transaction when the biometrics unit is abnormal.

In this invention, it is preferable that the control unit causes conditions of a transaction based on the biometrics authentication to be different from conditions of a transaction based on non-biometrics authentication in which verification against the individual data is performed.

In this invention, it is preferable that the control unit counts the number of transaction during abnormality of the biometrics unit, and transits to the non-biometrics authentication when the number of transaction during abnormality exceeds a preset number.

In this invention, it is preferable that the control unit clears the number of transaction during abnormality when the biometrics unit returns the normal state by maintenance and inspection of the biometrics unit.

In this invention, it is preferable that the control unit urges a transaction on another automated transaction device installed the biometrics authentication function by means of a guidance screen of the automated transaction device when the number of transaction during abnormal exceeds the preset number.

In this invention, it is preferable that the control unit causes withdrawal amount limit for a transaction based on the biometrics authentication to be different from the withdrawal amount limit for a transaction based on non-biometrics authentication in which verification of the individual data is performed.

In this invention, it is preferable that the control unit limits range of transactions based on the non-biometrics authentication beyond the range of transactions based on the biometrics authentication.

In this invention, it is preferable that the biometrics unit has an image capture device which captures an image of said body and an authentication unit which extracts the biometrics characteristic data from the captured images, verifies the extracted biometrics characteristic data against the registered biometrics characteristic data on the storage media, and performs individual authentication.

In this invention, it is preferable that the control unit has a middleware program which starts the biometrics unit, detects the abnormal of the biometrics unit by a response result of the biometrics unit, and executes the non-biometrics authentication when detecting abnormal, and a transaction processing program which controls an automated transaction mechanism to perform automated transaction operations according to the authentication result.

### BRIEF DESCRIPTION OF THE DRAWINGS

FIG. 1 shows the configuration of an automated transaction system of one embodiment of the invention;

FIG. 2 is a perspective view of the ATM of FIG. 1;

FIG. 3 is a block diagram of the ATM of FIG. 1;

FIG. 4 is a functional block diagram of the biological information verification processing of FIG. 3;

FIG. 5 is a side view showing the relation between the sensor of FIG. 4 and the palm of the hand;

FIG. 6 explains the blood vessel image of FIG. 4;

FIG. 7 explains the blood vessel image data of FIG. 4;

FIG. 8 shows the program configuration of the control unit in one embodiment of the invention;

FIG. 9 is a transaction processing flow diagram of a first embodiment of the program configuration of FIG. 8;

FIG. 10 shows the flow of maintenance and inspection processing related to the transaction processing of FIG. 9;

FIG. 11 shows the flow of transaction processing in a second embodiment employing the program configuration of FIG. 8;

FIG. 12 shows the flow of transaction processing in a third embodiment employing the program configuration of FIG. 8;

FIG. 13 explains a conventional palm image capture device;

FIG. 14 explains the principle of a conventional palm image capture device;

FIG. 15 shows explanation diagram of conventional palm authentication technology; and

FIG. 16 shows another explanation diagram of conventional palm authentication technology.

### DESCRIPTION OF THE PREFERRED EMBODIMENTS

Below, embodiments of the invention are explained, in the order of an automated transaction system, biometrics authentication processing, a first embodiment of an automated transaction control method, a second embodiment of an automated transaction control method, a third embodiment of an automated transaction control method, and other embodiments.

### Automated Transaction System

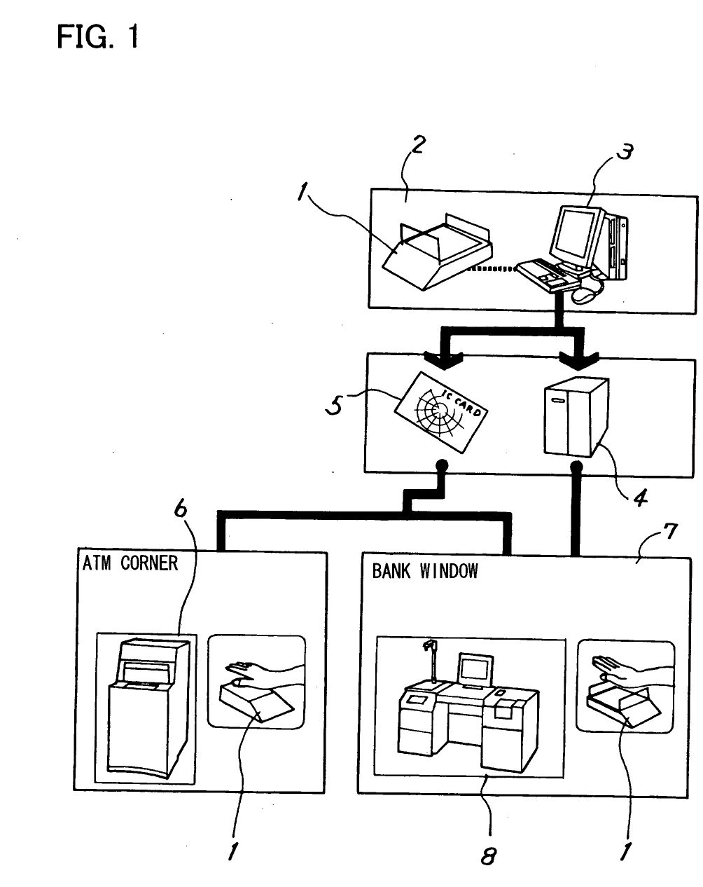

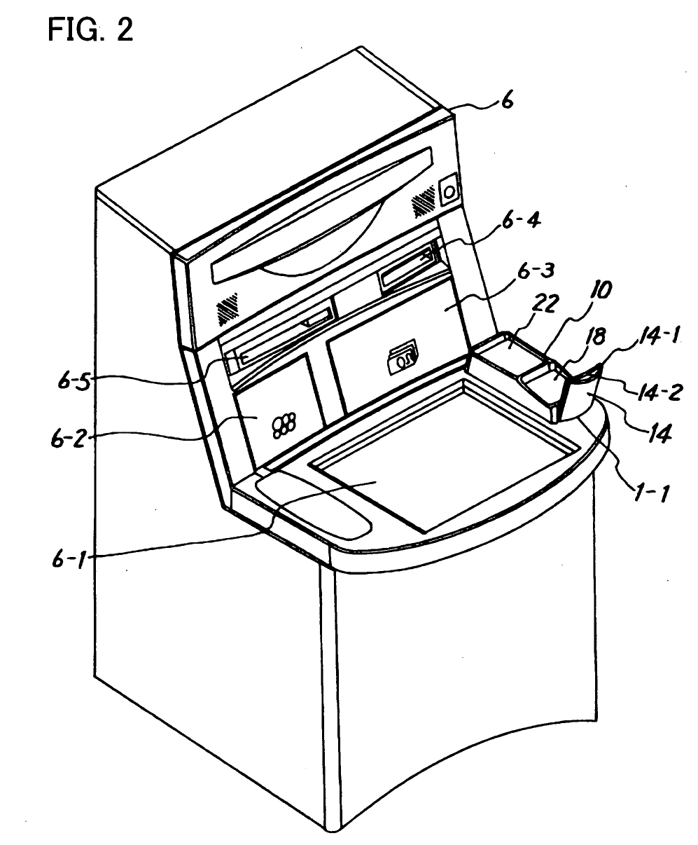

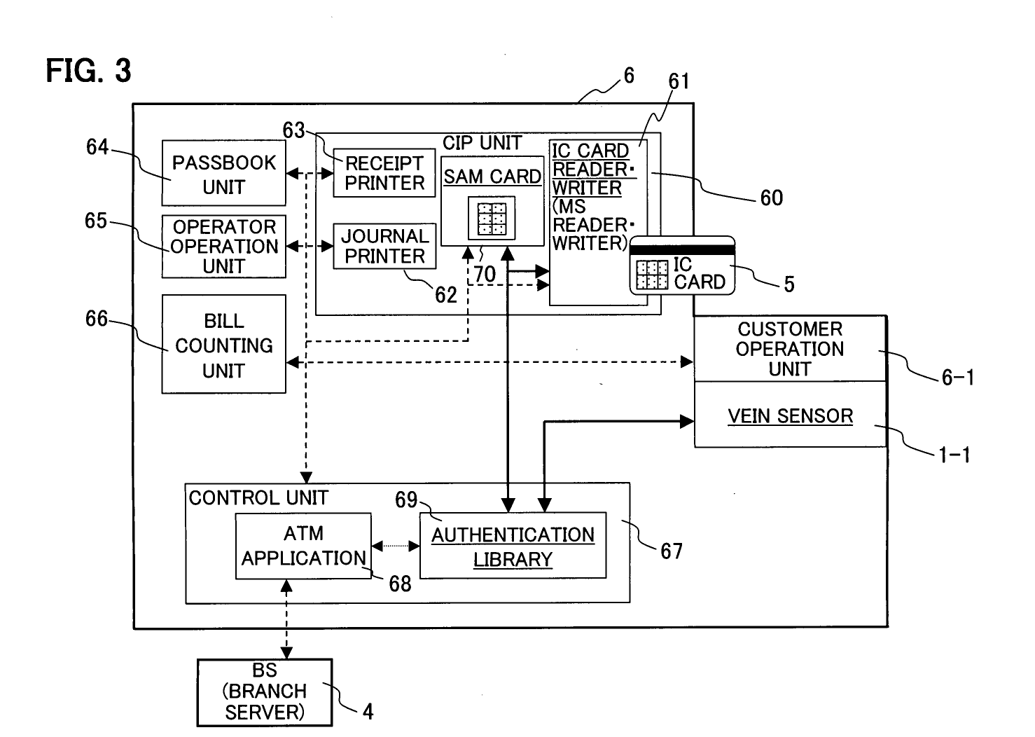

FIG. 1 shows the configuration of an automated transaction system of one embodiment of the invention, FIG. 2 is an external view of the automated transaction device of FIG. 1, and FIG. 3 shows the configuration of the automated transaction device of FIG. 2.

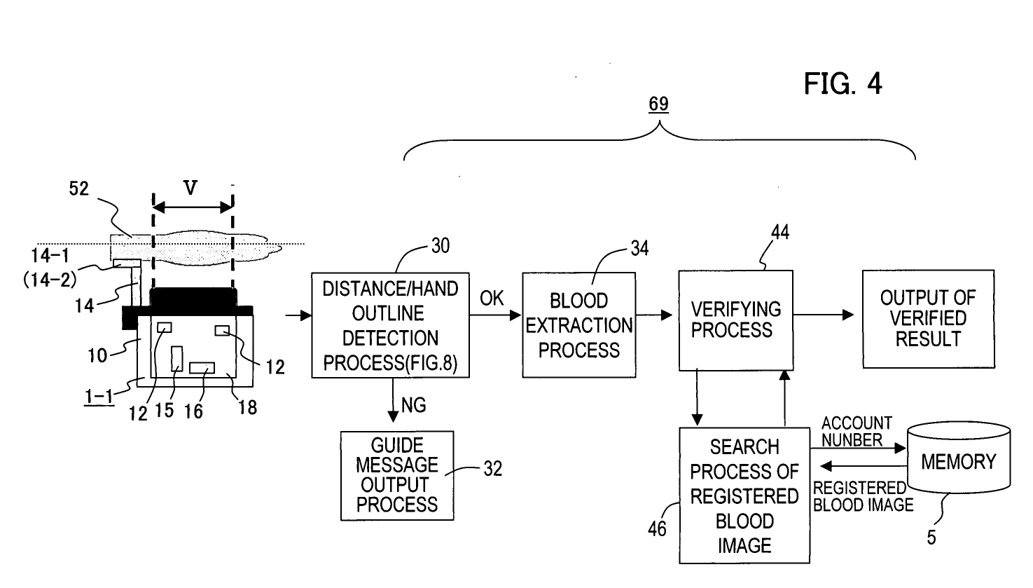

FIG. 1 shows an automated deposit/withdrawal system of a financial institution as the automated transaction system; as the biometrics authentication device, an example of a palm vein authentication device is shown. In the service area 2 of the financial institution are provided the palm image capture device 1 explained in FIG. 4 and a branch office terminal (for example, a personal computer) 3 connected thereto. A user requesting vein pattern authentication places his hand over the palm image capture device (hereafter the “image capture device”) 1. The image capture device 1 reads the palm, and blood vessel image extraction processing is performed, by the terminal 3 to extract the vein pattern, which is registered as vein data in the terminal 3.

This vein data is stored in a storage portion 4a of a database server 4 connected to the terminal 3, or in an individual card (for example, an IC card) 5 carried by the user. The server 4 is connected to a service area terminal 8 in the service area 7 of the financial institution, and the service area terminal 8 is connected to the image capture device 1.

The user places his hand over the image capture device 1 provided in the service area 7 in order to perform financial transaction. The image capture device 1 reads the palm, and the vein pattern is extracted by the blood vessel image extraction processing of the service area terminal 8. The service area terminal 8 verifies the vein pattern as vein data against the vein data registered in the database server 4 by means of the verification processing, and authenticates the individual.

The server 4 is connected to an ATM (automated cash deposit/withdrawal machine) 6 of the financial institution; the ATM 6 can be used in transactions based on vein authentication. In order to make a withdrawal or perform some other financial transaction using the ATM 6, the user holds his hand over the image capture device 1-1 provided in the ATM 6. The image capture device 1-1 reads the palm of the hand. Similarly to the service area terminal 8, the ATM 6 extracts the vein pattern (blood vessel image), and verifies this as vein data against the vein data registered in the IC card 5 carried by the user (or present in the database server 4), to authenticate the individual.

FIG. 2 and FIG. 3 show the configuration of the ATM (automated transaction machine) 6 of FIG. 1. As shown in FIG. 2, the ATM 6 has, on the front face thereof, a card insertion/ejection aperture 6-4; a bankbook insertion/ejection aperture 6-5; a paper currency insertion/dispensing aperture 6-3; a coin insertion/dispensing aperture 6-2; and a customer operation panel 6-1 for operation and display.

In this example, the image capture device 1-1 is provided on the side of the customer operation panel 6-1. The sensor unit 18 explained in FIG. 4 is mounted on the forward side of the main unit 10 of the image capture device 1-1. on the forward portion (on the user side) of the sensor unit 18 is provided a front guide 14. The front guide 14 comprises a sheet of synthetic resin, transparent or substantially transparent. In order to serve the purposes of guiding the hand of the user in the front and of supporting the wrist, the cross-sectional shape of the front guide 14 has a vertical body and, in the top portion, a horizontal portion 14-1 to support the wrist. A depression 14-2 is formed continuously in the center of the horizontal portion 14-1, to facilitate positioning of the wrist.

Further, the sensor unit 18 of the main unit 10 faces rearward and is inclined upward, and a flat portion 22 is provided therebehind.

As shown in FIG. 3, the ATM 1 has a CIP (Card Reader Printer) unit 60 having a card insertion/ejection aperture 6-4; a bankbook unit 64 having a bankbook insertion/ejection aperture 6-5; a paper currency/coin counter unit 66 having a paper currency insertion/dispensing aperture 6-3 and a coin insertion/dispensing aperture 6-2; an attendant operation unit 65; a control unit 67; a customer operation panel (UOP) 6-1 for operation and display; and an image capture device (vein sensor) 1-1.

The CIP unit 60 has an IC card reader/writer 60 which reads and writes the magnetic stripe and IC chip of an IC card 5; a receipt printer 63 which records transactions on a receipt; and a journal printer 62 which prints the history of transactions on journal forms.

The bankbook unit 64 records transactions on pages of a bankbook, and when necessary turns the pages. The attendant operation portion 65 displays the state and performs operations upon occurrence of a fault or during inspections by operation of an attendant. The paper currency/coin counting unit 66 validates, counts, and stores inserted paper currency and coins, and counts and dispenses paper currency and coins in the required quantities.

The control unit 67 communicates with the server 4, and has an ATM application (program) 68 which controls ATM operation and an authentication library (authentication processing program) 69 for biometrics authentication processing. A portion of this ATM application 68 acts in concert with the authentication library 69 to control biometrics authentication guidance screens of the UOP (customer operation panel) 6-1. The ATM application 68 has a function which compares the password data (individual data) on the magnetic stripe of the IC card 5 with the password data input from the UOP 6-1, to authenticate the individual.

### Biometrics Authentication Processing

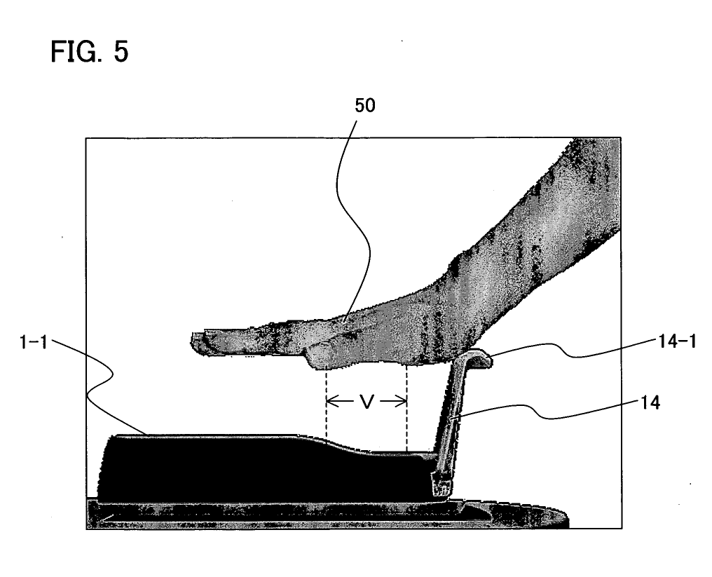

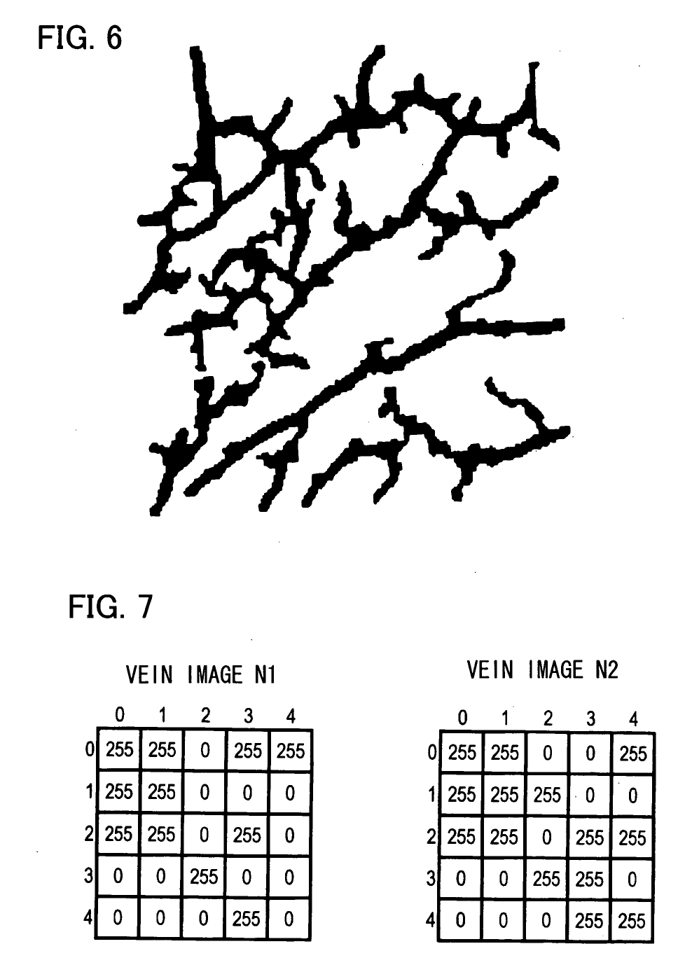

FIG. 4 is a block diagram of the biometrics authentication processing of an embodiment of the invention, FIG. 5 is a side view of the image capture device 1-1 of FIG. 4, FIG. 6 explains the detected blood vessel image in FIG. 4, and FIG. 7 explains the verification processing in FIG. 4.

As shown in FIG. 4, the palm image capture device 1-1 of FIG. 1 has a sensor unit 18 mounted substantially in the center of the main unit 10. A front guide 14 is provided in the forward portion (on the user side) of the sensor unit 18. The front guide 14 comprises a sheet of synthetic resin, transparent or substantially transparent.

The front guide 14 serves the purposes of guiding the hand of the user in the front and of supporting the wrist. Hence the front guide 14 provides guidance to the user to guide and support the wrist above the sensor unit 18. As a result, the attitude of the palm of the hand, that is, the position, inclination, and size over the sensor unit 18 can be controlled. The cross-sectional shape of the front guide 14 has a vertical body and, in the top portion, a horizontal portion 14-1 to support the wrist. A depression 14-2 is formed continuously in the center of the horizontal portion 14-1, to facilitate positioning of the wrist.

The sensor unit 18 is provided with an infrared sensor (CMOS sensor) and focusing lens 16 and a distance sensor 15 in the center; on the periphery thereof are provided a plurality of near-infrared light emission elements (LEDs) 12. For example, near-infrared light emission elements 12 are provided at eight places on the periphery, to emit near-infrared rays upwards.

The readable region V of this sensor unit 18 is regulated by the relation between the sensor, focusing lens, and near-infrared light emission region. Hence the position and height of the front guide 14 are set such that the supported wrist is positioned in the readable region V.

As shown in FIG. 5, when the hand 50 is extended with palm flat, the palm has maximum area, and moreover is flat, so that when the palm is subjected to image capture in the image capture region V of the sensor unit 18, an accurate vein pattern which can be used in registration and verification is obtained. As shown in FIG. 5, when the distance from the sensor unit 18 to the palm is within a prescribed range, a sharp and focused image is obtained by the sensor 16 of the sensor unit 18.

Hence as shown in FIG. 4, when the front guide 14 supports the wrist 52 above the sensor unit 18, the user's hand can be guided and supported so that the position, inclination and height of the palm above the sensor unit 18 are made precise with respect to the image capture range of the sensor unit 18.

Returning to FIG. 4, the authentication library (authentication program) 69 of the control unit 67 of the ATM 1 connected to the image capture device 1 executes a series of verification processing 30 to 46. The control unit 67 of the ATM 1 has, for example, a CPU, various types of memory, interface circuitry, and other circuits necessary for data processing. The CPU executes the series of verification processing 30 to 46.

Distance/hand outline detection processing 30 receives the distance from the image capture device 1-1 measured by the distance sensor 15, judges whether the palm or other object is at a distance within a prescribed range from the sensor unit 18, and detects the outline of the hand from the image captured by the sensor unit 18; and judges whether the image can be used in registration and verification processing based on the detected outline. For example, a judgment is made as to whether the palm appears sufficiently in the image.

Guidance message output processing 32 outputs to the UOP 6-1 of the ATM 6 a message guiding the palm to the left or right, forward or backward, upward or downward, when the distance measured by the distance sensor 15 indicates that the hand is outside the image capture range, and when hand outline detection processing 30 indicates that the image cannot be used in registration and verification processing. By this means, the hand of the user is guided into position over the image capture device 1-1.

Blood vessel image extraction processing 34 extracts a vein image from the image of the hand when hand outline detection processing 30 judges that an image has been captured with the hand held correctly. That is, as explained in FIG. 10 and FIG. 11, grayscale data of the image of the palm such as that of FIG. 7 is obtained through differences in reflectivity. The vein pattern image is an image like that shown in FIG. 6; the data is grayscale data such as that in FIG. 7.

Registered blood vessel image search processing 46 searches a storage portion (IC chip memory) of the IC card 5 shown in FIG. 3 for three registered blood vessel image data sets R1, R2, R3 corresponding to the individual ID (account number). As shown in FIG. 7, verification processing 44 compares the blood vessel image data N1 detected by the blood vessel image detection processing 34 with the registered blood vessel image data N2 (R1, R2, R3), performs verification processing, and outputs a verification result to the ATM application 68.

In order to install such a biometrics authentication system, the biometrics reader device (image capture device) 1-1 and the authentication program 69 must be installed in the automated transaction machine 6.

### Automated Transaction Control Processing of a First Embodiment

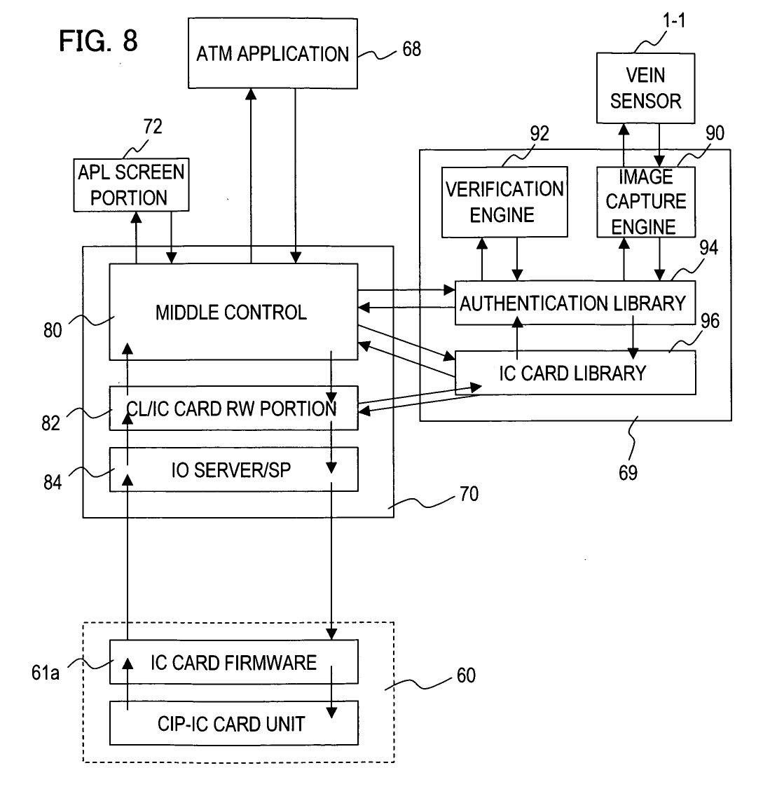

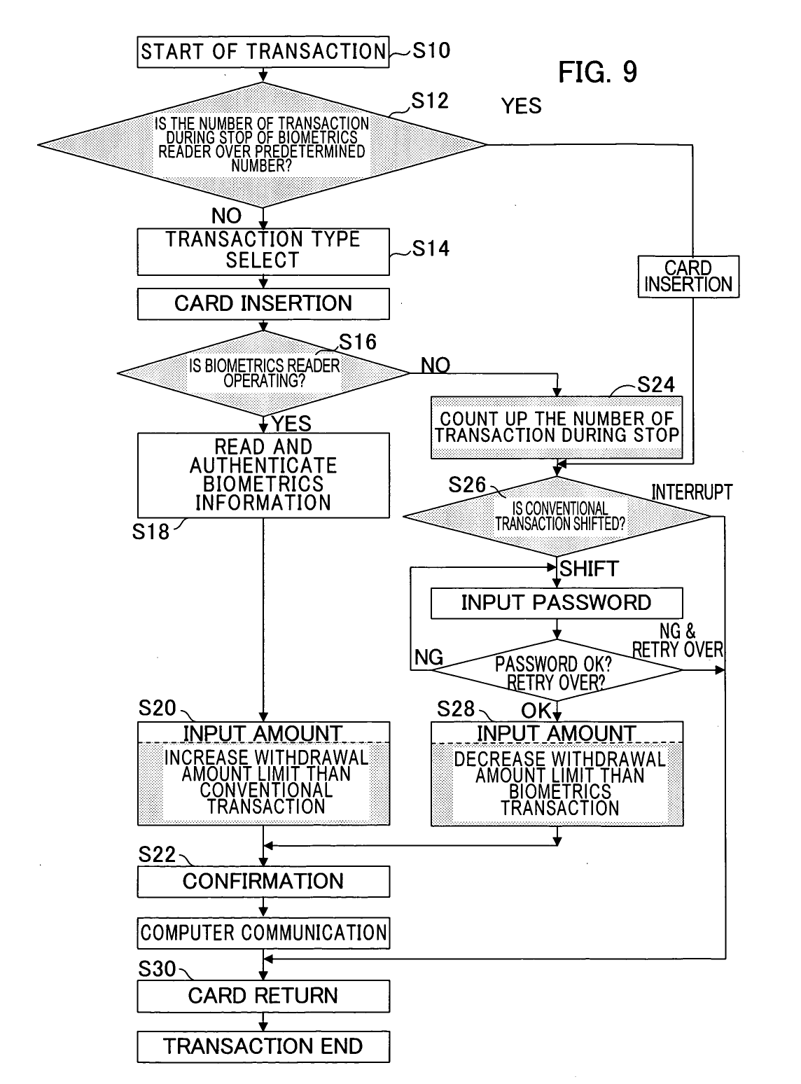

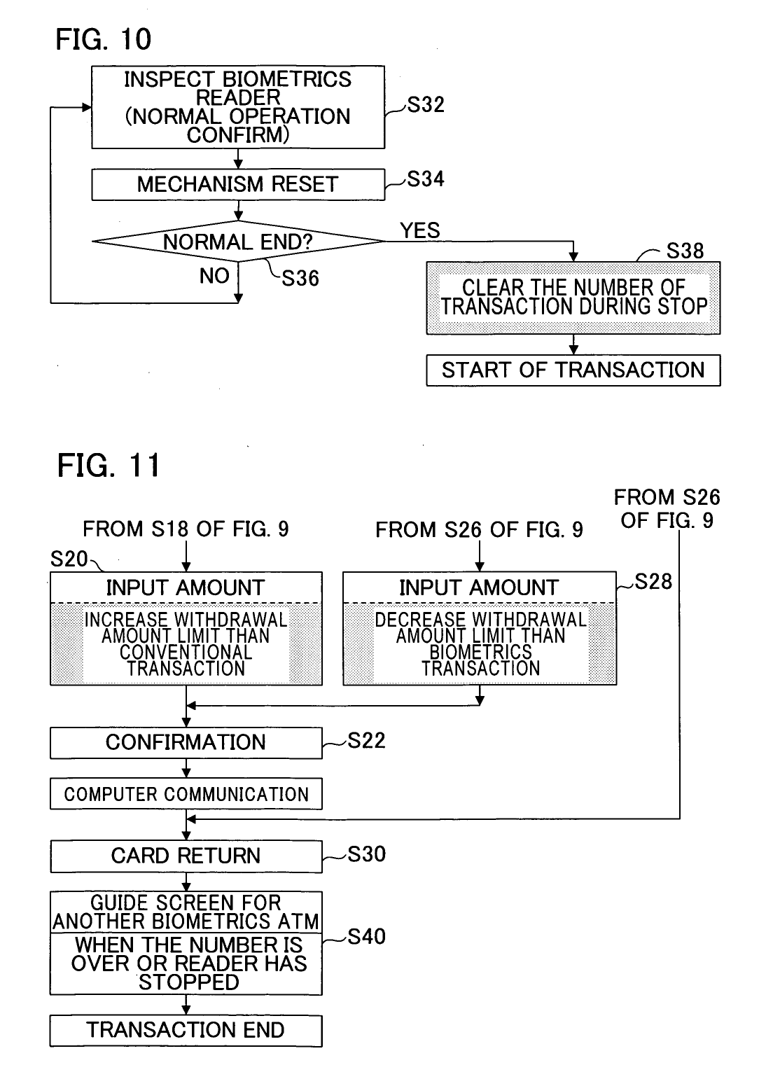

FIG. 8 shows the configuration of an ATM program of one embodiment of the invention, and FIG. 9 shows the transaction processing flow by a program configured as in FIG. 8.

FIG. 8 shows the program configuration of the control unit 67 of the ATM 6 that a vein sensor 1-1 is equipped and moreover an authentication program 69 is installed as shown in FIG. 3. As shown in FIG. 8, middleware programs 70, 72 are positioned between an ATM application 68 which performs transaction processing and the IC card firmware 61a of the IC card reader/writer 60. The middleware program 70 queries the authentication program 69 and determines the automated transaction method in response to the start of a transaction by the ATM application 68.

That is, the middleware program 70 has an IO server/SP portion 84, which functions as a server and supervisor of the IC card firmware program 61a; a CL/IC card RW portion 82, which functions as a client of the IC card reader/writer; and a middle control portion 80, connected to the CL/IC card RW portion, and which initializes the authentication program 69. This middle control portion 80 exchanges data with the ATM application 68, and controls the application screen portion 72.

On the other hand, the authentication program 69 has an IC card library 96, which reads biometrics data in the IC card 5 using the IC card reader/writer 61; an image capture engine 90, which controls image capture by the vein sensor 1-1; a verification engine 92, which performs the above-described verification processing 44 of FIG. 4; and an authentication library 94, which causes the IC card reader library 96 to execute the above-described registered blood vessel search processing 46 of FIG. 4, and also causes the image capture engine 90 to execute the above-described distance/hand outline detection processing 30 and blood vessel extraction processing 34 of FIG. 4. This authentication library 94 is initialized by the middle control portion 80, initiates authentication processing, and returns a verification result.

The transaction processing of the first embodiment by the program of FIG. 8 is explained, using the flow diagram of FIG. 9.

(S10) The ATM application 68 detects touching of the screen of the UOP 6-1, and initiates a transaction.

(S12) The ATM application 68 judges whether the number of transactions during stoppage of the biometric device 1-1 provided within the control unit 67 is equal to or greater than a preset number. For example, the preset number may be five. As explained below, the number of transactions during stoppage of the biometrics device 1-1 is the number of times, at the start of a transaction, that the biometrics device 1-1 has been judged to be stopped, due to a hardware error in the biometrics device, disconnection of a connection socket, or for some other reason. If the number of transactions during stoppage is equal to or greater than the preset number, a transaction based on biometrics authentication is judged to be not possible, the user is prompted to insert a card 5, and processing advances to step S26.

(S14) When the number of transactions during stoppage is not equal to or greater than the preset number, the ATM application 68 displays a transaction type selection screen on the UOP 6-1. The user uses the UOP 6-1 to input the transaction type. The ATM application 68, upon judging that a cash-dispensing transaction (withdrawal, transfer) has been selected, displays a card insertion screen on the UOP 6-1. When the user inserted an IC card 5 into the insertion aperture 6-4, the IC card reader/writer 61 reads the data on the magnetic stripe of the IC card 5. This data contains the account number of the user and similar.

(S16) In order to initiate biometrics authentication, the ATM application 68 instructs the middle control portion 80 to initiate authentication. As a result, the middle control portion 80 issues an initialization instruction to the authentication library 94 and IC card library 96, to read biometrics information and perform authentication. The authentication library 94 and IC card library 96 perform initialization operations for various portions. At this time, the authentication library 94 also performs processing to initialize the vein sensor 1-1. In this initialization processing, a judgment is made as to whether the vein sensor 1-1 can operate. For example, if there is no response even when an initialization command is issued to the vein sensor 1-1, a response is sent to the middle control portion 80 indicating no response. As a result, the middle control portion 80 judges that the vein sensor 1-1 is not in an operating state, and processing advances to step S24.

(S18) On the other hand, when the vein sensor 1-1 is in the operating state, the middle control portion 80 receives the account number read from the magnetic stripe of the IC card by the ATM application 68 from the IC card reader-writer 61 through insertion of the IC card 5, and notifies the IC card library 96. The IC card library 96 reads registered blood vessel image data corresponding to the account number on the IC card 5 from the IC card firmware 61a, via the CL/IC card RW portion 82 and IO server/SP 84 (see FIG. 4). The authentication library 94 which has been started causes the image capture engine 90 to execute the image acquisition operation of the vein sensor 1-1, including the above-described distance/hand outline detection processing 30 and blood vessel image extraction processing 34 of FIG. 4. The authentication library 94 then sends the extracted blood vessel image obtained from image capture by the vein sensor 1-1 and the registered blood vessel image to the verification engine 92, and causes verification processing to be performed. The middle control portion 80 is notified of each of the states of progress of the authentication library 94, and the middle control portion 80 displays the state of progress (reading, verifying, verification result) on the UOP 6-1 by means of the APL screen portion 72. Upon being notified by the authentication library 94 that a verification result is not satisfactory (NG), the middle control portion 80 increments the number of retries by “1”. A judgment is then made as to whether the number of retries has exceeded a preset number of retries (for example, three) (retry over). If the number of retries has exceeded the preset number of retries, a transaction based on biometrics authentication is judged to be not possible, and processing advances to step S26.

(S20) Upon being informed by the authentication library 94, within the preset number of retries, that the verification result is satisfactory (OK), the middle control portion 80 notifies the ATM application 68 of the normal end of authentication. As a result, the ATM application 68 displays a monetary amount input/confirmation screen on the UOP 6-1 to perform monetary amount input, which is normal transaction processing after authentication. In this case, because security is maintained, the withdrawal amount limit is raised above the withdrawal amount limit for a conventional transaction, described below in step S28. The ATM application 68 checks whether monetary amount input by the user is within the withdrawal amount limit.

(S22) When the user performs an operation to confirm the monetary amount, the ATM application 68 communicates with a computer (the host), and displays a screen to this effect on the UOP 6-1. Processing then advances to step S30.

(S24) If on the other hand the middle control portion 80 judges that there is an abnormal with the vein sensor 1-1 in step S16, the number of transactions during stoppage of the biometrics device in the control unit 67 is incremented.

(S26) In steps S12 and S16, if it is judged that a transaction based on biometrics authentication is not possible, a judgment is made as to whether to make a transition to a conventional transaction, based on the user screen selection or on user setting information. In cases where no transition is made, that is, an interruption instruction is issued and set, an interruption screen is displayed on the UOP 6-1 by the APL screen portion 72, and an interruption response is sent to the ATM application 68. The ATM application advances to step S28. If on the other hand an interruption is not instructed and set, the middle control portion 80 responds to the ATM application 68 indicating a conventional transaction. The ATM application 68 performs automated transaction processing based on a conventional password. That is, a password input screen is displayed, a password number is input, the input password number is verified against the password number corresponding to the account number on the IC card 5, and if the verification result is satisfactory, processing advances to step S28. If on the other hand the verification result is not satisfactory, the user is prompted to retry password number input. And if the verification result is not satisfactory even when the number of retries has reached the prescribed number, a screen indicating the transaction is not possible is displayed, and processing advances to step S30.

(S28) The ATM application 68 displays a monetary amount input/confirmation screen on the UOP 6-1 to perform monetary amount input, which is normal transaction processing after authentication. In this case, because security is not maintained, the withdrawal amount limit is lowered below the withdrawal amount limit for a transaction based on biometrics authentication, described above in step S20. The ATM application 68 checks whether monetary amount input by the user is within the withdrawal amount limit. Processing then returns to step S22.

(S30) The monetary amount is input, and if the host response obtained through computer communication is satisfactory, either one of withdrawal, deposit, and fund transfer for the account is performed, and the IC card 5 and a receipt are returned. Then processing ends.

In this way, even when there is an abnormal in the biometrics unit in an automated transaction device having biometric authentication functions, a transition is made to a conventional transaction based on password authentication using an IC card. So even in the event of an abnormality in the biometrics device, transactions based on other, non-biometrics authentication are possible, contributing to improved convenience to the user.

The number of transactions during stoppage of the biometrics readout device (image capture device) 1-1 is increased, and if equal to or greater than the preset number, biometrics authentication is not started, and a transition is made to a conventional transaction. Hence even if there is an abnormal in the biometrics device, transactions based on conventional authentication are possible until device maintenance staff arrives and restores the device to normal. For example, even in after-hours operation, services provided to customers are not curtailed so drastically, and in maintenance of the equipment, some margin is gained in choosing the time to dispatch device maintenance staff.

Further, the withdrawal amount limit for transactions based on biometrics authentication can be increased compared with the withdrawal amount limit for conventional transactions (with authentication using a password), so that withdrawal transactions commensurate with the degree of security are possible. That is, when a biometrics authentication result is NG, damages due to illicit acts are reduced even in the case of a conventional transaction.

Moreover, this embodiment is realized through middleware, and so can be realized without altering the conventional ATM application 68.

FIG. 10 shows the flow of maintenance and inspection processing of the biometrics device 1-1 related to FIG. 9.

(S32) When maintenance staff maintains and inspects the automated transaction device 6, the error state of the biometric device 1-1 is investigated using the attendant operation portion 65 of the automated transaction device 6, and maintenance and inspections are performed. That is, the cause of the error in the biometrics device 1-1 is checked and inspected by the maintenance staff. For example, inspections are performed to determine whether plugs are unplugged, whether the device 1-1 itself is operating properly, and similar. The maintenance staff confirms normal operation. If operation is not normal, the device is replaced.

(S34) Upon confirming normal operation, the maintenance staff issues an instruction for mechanism reset from the attendant operation portion 65.

(S36) As a result of the mechanism reset instruction, the device operates, and the device is checked for a normal end of operation. If the end of operation is not normal, processing returns to step S32.

(S38) If on the other hand the end of operation is normal, the biometrics device 1-1 can function normally, and so the number of transactions during stoppage of the biometrics device 1-1 of the control unit 67 is cleared. A transition is then made to the transaction start state.

### Automated Transaction Control Method of a Second Embodiment

FIG. 11 shows the flow of processing of a second embodiment, which is an automated transaction control method of this invention. Similarly to FIG. 9, the program configuration of FIG. 8 is used. This embodiment adds step S40 to the flow of processing of FIG. 9; otherwise, the flow of processing is the same as in FIG. 9. Hence a portion of FIG. 9 is omitted, portions which are the same are assigned the same symbols, and explanations of the same portions are omitted.

(S40) At the time the card is returned in step S30, if the number of transactions during stoppage of the biometrics device 1-1 is equal to or greater than the preset number in steps S12 or S16 of FIG. 9, or if the biometrics device 1-1 is currently stopped, a screen guiding the user to another automated transaction device comprising a biometrics device is displayed on the UOP 6-1. For example, text such as “The biometrics device of this machine is currently stopped; your transaction can be performed at another automated transaction machine having a biometrics device”, or an illustration (indicating the location of the other machine), or similar is displayed.

By this means, even in conventional transactions, or even when a conventional transaction is interrupted, the user is able to understand that the transaction can be performed at another automated transaction device comprising a biometrics device, contributing to improved convenience to the user.

### Automated Transaction Control Method of a Third Embodiment

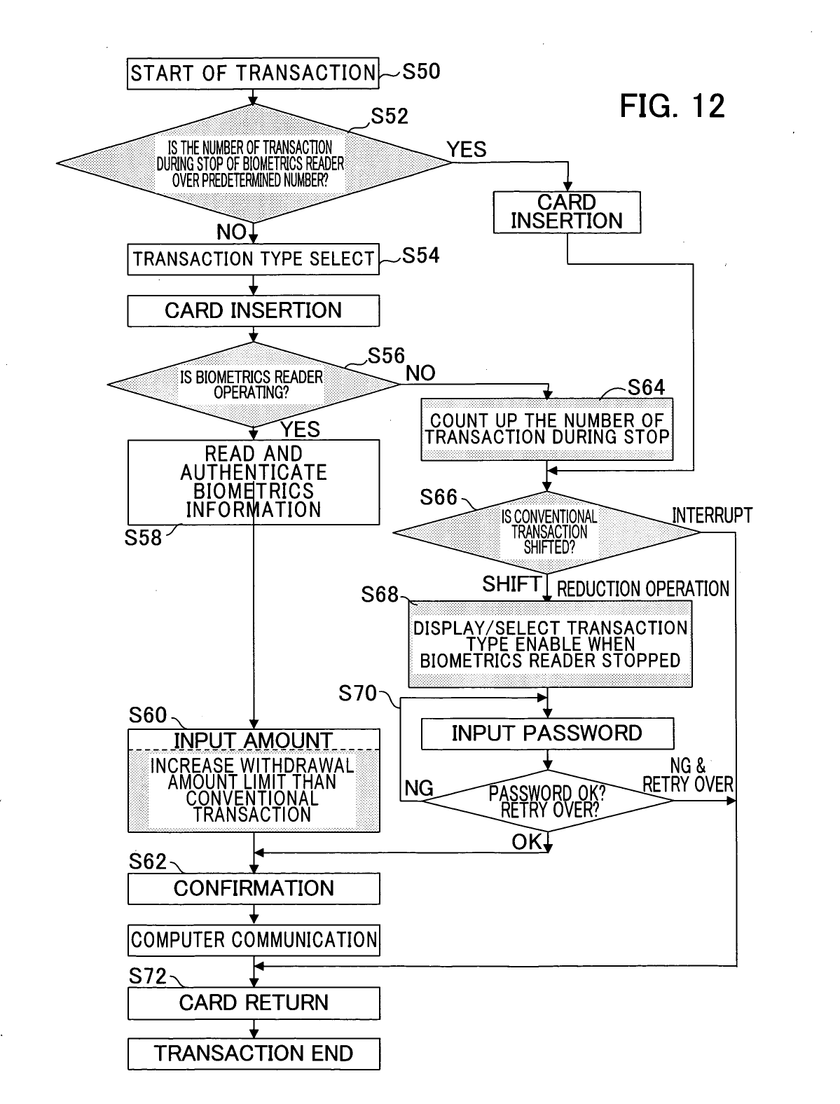

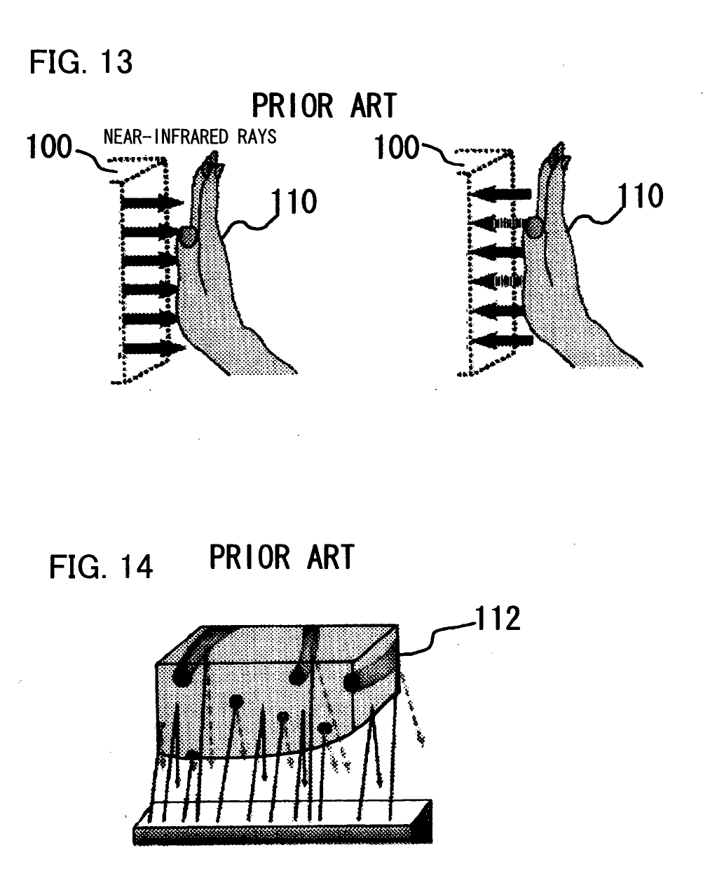

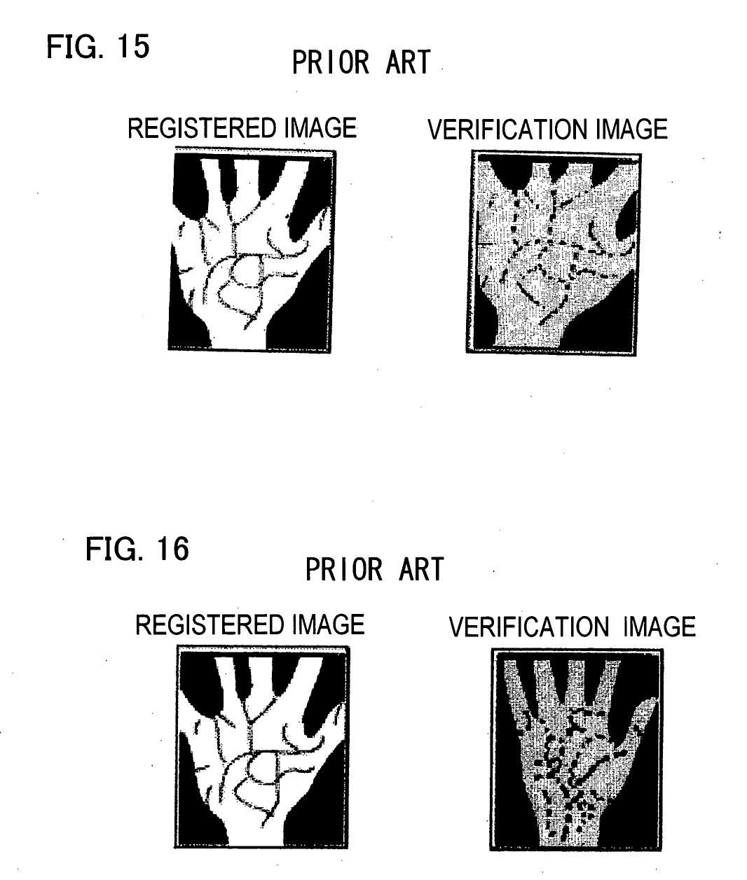

FIG. 12 shows the transaction processing flow by the program configuration of FIG. 8, in a third embodiment of the invention.

(S50) Similarly to step S10, the ATM application 68 detects touching of the screen of the UOP 6-1, and initiates a transaction.

(S52) Similarly to step S12, the ATM application 68 judges whether the number of transactions during stoppage of the biometrics device 1-1 provided within the control unit 67 is equal to or greater than a preset number. If the number of transactions during stoppage is equal to or greater than the preset number, a transaction based on biometrics authentication is judged to be not possible, the user is prompted to insert a card 5, and processing advances to step S66.

(S54) Similarly to step S14, when the number of transactions during stoppage is not equal to or greater than the preset number, the ATM application 68 displays a transaction type selection screen on the UOP 6-1. The user uses the UOP 6-1 to input the transaction type. The ATM application 68, upon judging that a cash-dispensing transaction (withdrawal, transfer) has been selected, displays a card insertion screen on the UOP 6-1. When the user inserted an IC card 5 into the insertion aperture 6-4, the IC card reader/writer 61 reads the data on the magnetic stripe of the IC card 5. This data contains the account number of the user and similar.

(S56) Similarly to step S16, in order to initiate biometrics authentication, the ATM application 68 instructs the middle control portion 80 to initiate authentication. As a result, the middle control portion 80 issues an initialization instruction to the authentication library 94 and IC card library 96, to read biometrics information and perform authentication. The authentication library 94 and IC card library 96 perform initialization operations for various portions. At this time, the authentication library 94 also performs processing to initialize the vein sensor 1-1. In this initialization processing, a judgment is made as to whether the vein sensor 1-1 can operate. For example, if there is no response even when an initialization command is issued to the vein sensor 1-1, a response is sent to the middle control portion 80 indicating no response. As a result, the middle control portion 80 judges that the vein sensor 1-1 is not in an operating state, and processing advances to step S64.

(S58) On the other hand, when the vein sensor 1-1 is in the operating state, similarly to step S18, the middle control portion 80 receives the account number read from the magnetic stripe of the IC card by the ATM application 68 from the IC card reader-writer 61 through insertion of the IC card 5, and notifies the IC card library 96. The IC card library 96 reads registered blood vessel image data corresponding to the account number on the IC card 5 from the IC card firmware 61a, via the CL/IC card RW portion 82 and IO server/SP 84 (see FIG. 4). The authentication library 94 which has been started causes the image capture engine 90 to execute the image acquisition operation of the vein sensor 1-1, including the above-described distance/hand outline detection processing 30 and blood vessel image extraction processing 34 of FIG. 4. The authentication library 94 then sends the extracted blood vessel image obtained from image capture by the vein sensor 1-1 and the registered blood vessel image to the verification engine 92, and causes verification processing to be performed. The middle control portion 80 is notified of each of the states of progress of the authentication library 94, and the middle control portion 80 displays the state of progress (reading, verifying, verification result) on the UOP 6-1 by means of the APL screen portion 72. Upon being notified by the authentication library 94 that a verification result is not satisfactory (NG), the middle control portion 80 increments the number of retries by “1”. A judgment is then made as to whether the number of retries has exceeded a preset number of retries (for example, three) (retry over). If the number of retries has exceeded the preset number of retries, a transaction based on biometrics authentication is judged to be not possible, and processing advances to step S66.

(S60) Upon being informed by the authentication library 94, within the preset number of retries, that the verification result is satisfactory (OK), the middle control portion 80 notifies the ATM application 68 of the normal end of authentication. As a result, the ATM application 68 displays a monetary amount input/confirmation screen on the UOP 6-1 to perform monetary amount input, which is normal transaction processing after authentication. In this case, because security is maintained, the withdrawal amount limit is raised above the withdrawal amount limit for a conventional transaction, described below in step S28. The ATM application 68 checks whether monetary amount input by the user is within the withdrawal amount limit.

(S62) When the user performs an operation to confirm the monetary amount, the ATM application 68 communicates with a computer (the host), and displays a screen to this effect on the UOP 6-1. Processing then advances to step S72.

(S64) If on the other hand the middle control portion 80 judges that there is an abnormal with the vein sensor 1-1 in step S56, the number of transactions during stoppage of the biometrics device in the control unit 67 is incremented.

(S66) In steps S52 and S56, if it is judged that a transaction based on biometrics authentication is not possible, a judgment is made as to whether to make a transition to a conventional transaction, based on the user screen selection or on user setting information. In cases where no transition is made, that is, an interruption instruction is issued and set, an interruption screen is displayed on the UOP 6-1 by the APL screen portion 72, and an interruption response is sent to the ATM application 68. The ATM application advances to step S72.

(S68) If on the other hand an interruption is not instructed and set in step S66, the middle control portion 80 responds to the ATM application 68 indicating a conventional transaction. The ATM application 68 performs degraded automated transaction processing based on a conventional password. Balance confirmation is an example of a degraded automated transaction.

(S70) That is, the password input screen is displayed, the password number is input, the input password number is verified against the password number corresponding to the account number on the IC card 5, and if the verification result is satisfactory, balance confirmation processing is initiated, and processing advances to step S62. If on the other hand the verification result is not satisfactory, the user is prompted to retry password number input, and verification is performed. If the verification result is not satisfactory even when the number of retries reaches a prescribed number, a screen indicating the transaction is not possible is displayed, and processing advances to step S72.

(S72) A monetary amount is input, and if the host response obtained through computer communication is satisfactory, either withdrawal, deposit, or fund transfer for the account is performed, or balance confirmation is performed when executed step S62. The number of authentication NG attempts is written on the IC card 5, and a receipt is returned.

At this time, similarly to FIG. 11, if in steps S52 and S56 the biometrics device is stopped, the middle control portion 80 displays on the UOP 6-1 a screen guiding the user to another automated transaction device comprising a biometrics device. As a result, the individual can use another machine for automated transactions through biometrics authentication.

Thus even when there is an abnormal in the biometrics unit of an automated transaction device having biometrics authentication functions, a transition can be made to a conventional transaction based on password authentication using an IC card, so that transactions based on other non-biometrics authentication are possible even when there is an abnormal in the biometrics device, contributing to improved convenience to the user.

Further, the number of transactions during stoppages of the biometrics readout device (image capture device) 1-1 is increased, and if the number is equaled or exceeded a preset number, a transition is made to a conventional transaction without starting biometrics authentication. Hence even if there is an abnormal in the biometrics device, transactions based on conventional authentication are possible until maintenance staff for the machine arrives and operation is returned to normal. For example, even in after-hours operation, services provided to customers are not curtailed so drastically, and in maintenance of the equipment, some margin is gained in choosing the time to dispatch device maintenance staff.

Further, compared with transactions based on biometrics authentication, the range of conventional transactions (based on authentication using a password) is limited, so that transactions which require authentication according to the level of security are possible. That is, when the result of biometrics authentication is NG, damages due to illicit acts are reduced even in the case of a conventional transaction.

Further, this embodiment is realized using middleware, and so there is no need to modify a conventional ATM application 68.

### Other Embodiments

In the above-described aspects, biometrics authentication was explained for the case of authentication using vein patterns in the palm of the hand; but application to other biometrics authentication, such as vein patterns in the fingers, palm-prints, or other features of the palm of the hand, as well as to fingerprints, facial features, and similar is also possible. Moreover, the case of automated equipment for financial operations was explained, but application to automated ticket issuing equipment, automated vending equipment, and to automated machines and computers in other areas, as well as to door opening/closing equipment in place of keys, and to other equipment where individual authentication is required, is also possible.

Similarly, the middle control portion 80 starts the authentication program 69 and controls biometric authentication and traditional transactions; but execution by the ATM application and an authentication program is also possible.

Moreover, cards are not limited to IC cards, and other storage media may be used; authentication in conventional transactions is not limited to passwords, but can use other non-biometrics authentication means such as seals, signatures, or similar.

In the above, embodiments of the invention have been explained; but the invention can be variously modified within the scope of the invention, and these modifications are not excluded from the scope of the invention.

In an automated transaction device having biometric authentication functions, a transition can be made to conventional transactions based on non-biometrics authentication using a card held by the user even when there is an abnormal in the biometrics unit, so that automated transactions are possible even when there is an abnormal in the biometrics unit, contributing to improved convenience for the user.

What is claimed is:

1. An automated transaction device, which reads individual data from storage media held by a user, verifies said read data against input individual data, and performs automated transactions, comprising:
a media reading unit which reads storage media of said user;
a biometrics unit which verifies registered biometrics characteristic data according to the individual data of said storage media against said biometrics characteristic data detected from a body of said user, and performs individual authentication; and
a control unit which performs automated transactions according to the authentication result of said biometrics unit,
and wherein at the start of said automated transaction, said control unit detects whether or not said biometrics unit is abnormal, effects a transition to non-biometrics authentication in which individual data of said recording media is verified against input individual data, and the automated transaction is executed when detecting the abnormal.

2. The automated transaction device according to claim 1, wherein said control unit causes the conditions of a transaction based on said biometrics authentication to be different from the conditions of a transaction based on non-biometrics authentication in which verification against said individual data is performed.

3. The automated transaction device according to claim 1, wherein said control unit counts the number of transactions during an abnormal of said biometrics unit, and when said number of transactions during an abnormal exceeds a preset number, effects a transition to said non-biometrics authentication.

4. The automated transaction device according to claim 3, wherein, at the time of recovery to normal operation through maintenance and inspection of said biometrics unit, said control unit clears said number of transactions during abnormal.

5. The automated transaction device according to claim 3, wherein, when said number of transactions during abnormal exceeds a preset number, said control unit provides guidance for use of another automated transaction device comprising said biometrics authentication functions, by means of a guidance screen of said automated transaction device.

6. The automated transaction device according to claim 2, wherein said control unit causes the withdrawal amount limit for a transaction based on said biometrics authentication to be different from the withdrawal amount limit for a transaction based on non-biometrics authentication in which verification of said individual data is performed.

7. The automated transaction device according to claim 2, wherein said control unit limits the range of transactions based on said non-biometrics authentication compared with the range of transactions based on said biometrics authentication.

8. The automated transaction device according to claim 1, wherein said biometrics unit comprises:
an image capture device which captures an image of said body; and
an authentication unit which extracts said biometrics characteristic data from said captured images, verifies said biometrics characteristic data against said registered biometrics characteristic data on said storage media, and performs individual authentication.

9. The automated transaction device according to claim 1, wherein said control unit has:
a middleware program which, at the time of initiation of a transaction, starts said biometrics unit, and based on the result of a response from said biometrics unit detects abnormal in said biometrics unit, and executes said non-biometrics authentication; and
a transaction processing program which controls an automated transaction mechanism to perform automated transaction operations, according to said authentication result.

10. An automated transaction control method, comprising the steps of:
detecting abnormal in a biometrics unit;
verifying biometrics characteristic data registered based on individual data on said storage media against said biometrics characteristic data detected from a body of a user using a biometrics unit, and performing biometrics authentication when said biometrics unit is normal;
executing an automated transaction based on said biometrics authentication when the result of said biometrics authentication is satisfactory; and
verifying individual data of said storage media against input individual data, performing non-biometrics authentication for individual authentication, and executing an automated transaction when there is an abnormal in said biometrics unit.

11. The automated transaction control method according to claim 10, further comprising a step of causing the conditions of a transaction based on said biometrics authentication to be different from the conditions of a transaction based on non-biometrics authentication in which verification of said individual data is performed.

12. The automated transaction control method according to claim 10, further comprising the steps of:
counting the number of transactions during an abnormal of said biometrics unit;
judging whether or not said number of transactions during abnormal exceeds a preset number; and
effecting a transition to said non-biometrics authentication when said number of transactions during abnormal exceeds a preset number.

13. The automated transaction control method according to claim 12, further comprising a step, at the time of recovery to normal operation through maintenance and inspection of said biometrics unit, of clearing said number of transactions during abnormal.

14. The automated transaction control method according to claim 10, further comprising a step, when there is an abnormal in said biometrics unit, of providing guidance for use of another automated transaction device having said biometrics authentication functions, by means of a guidance screen of said automated transaction device.

15. The automated transaction control method according to claim 11, wherein said step of causing transaction conditions to be different comprises a step of causing the withdrawal amount limit of a transaction based on said biometrics authentication to be different from the withdrawal amount limit of a transaction based on said non-biometrics authentication in which verification of said individual data is performed.

16. The automated transaction control method according to claim 11, wherein said step of causing transaction conditions to be different comprises a step of causing the range of transactions based on said non-biometrics authentication to be limited compared with the range of transactions based on said biometrics authentication.

17. The automated transaction control method according to claim 10, wherein said biometrics authentication step is executed by an image capture device which captures images of said body, and by an authentication unit which extracts said biometrics characteristic data from said captured images, verifies said biometrics characteristic data against said registered biometrics characteristic data of said storage media, and performs individual authentication.

18. The automated transaction control method according to claim 10, further comprising:
a step of stating said biometrics unit, judging an abnormal in said biometrics unit based on the response from said biometrics unit, executing said non-biometrics authentication with middleware program; and
a step of controlling an automated transaction mechanism which performs automated transaction operations, according to said authentication result with a transaction processing program.

19. A computer readable storage medium stored program, which causes a computer to execute the steps of:
detecting abnormal in said biometrics unit;
verifying biometrics characteristic data registered based on individual data on a storage media against said biometrics characteristic data detected from a body of a user using a biometrics unit, and performing biometrics authentication when said biometrics unit is normal;
executing an automated transaction based on said biometrics authentication when the result of said biometrics authentication is satisfactory; and
verifying individual data of said storage media against input individual data, performing non-biometrics authentication for individual authentication, and executing an automated transaction when there is an abnormal in said biometrics unit.

20. The computer readable storage medium stored program according to claim 19, causing the computer to further execute the steps of:
counting the number of transactions during an abnormal of said biometrics unit;
judging whether or not said number of transactions during abnormal exceeds a preset number; and
effecting a transition to said non-biometrics authentication when said number of transactions during abnormal exceeds a preset number.
